(19) United States
(12) Patent Application Publication
(10) Pub. No.: US 2025/0244603 A1
(43) Pub. Date: Jul. 31, 2025

(54) HOLOGRAPHIC VIDEO DISPLAY METHOD, HOLOGRAPHIC VIDEO DISPLAY DEVICE, AND VIDEO DATA CREATION METHOD

(71) Applicant: I.B.RESEARCH Inc., Niigata (JP)

(72) Inventors: Masato FUJISAWA, Niigata (JP); Mao KAGAMI, Niigata (JP); Setsuko TERASHIMA, Niigata (JP)

(21) Appl. No.: 19/086,042

(22) Filed: Mar. 20, 2025

Related U.S. Application Data
(63) Continuation of application No. PCT/JP2024/039101, filed on Nov. 1, 2024.

(30) Foreign Application Priority Data
Dec. 28, 2023 (JP) 2023-222222

(51) Int. Cl. G02B 30/54

(52) U.S. Cl. CPC G02B 30/54

(57) ABSTRACT

A holographic video display method includes: a step of reading, from a storage medium, video data including a plurality of pieces of image data in which a plurality of images are arranged on a surface of an annular region or a spherical region, the images moving along the surface of the annular region or the spherical region; and a step of displaying a holographic video based on the video data by changing luminance of the light sources based on the video data, in the holographic video display device, in which in the pieces of image data, among the images, a color of a first image and a color of a second image at a point symmetry position with the first image with respect to a center of the annular region or the spherical region are different from each other.

### RELATED APPLICATIONS

This present application is a continuation application of International Application No. PCT/JP2024/039101, filed on Nov. 1, 2024, which claims priority to Japanese Patent Application No. 2023-222222, filed Dec. 28, 2023. The contents of which applications are incorporated herein by reference in their entirety.

### FIELD

The present invention relates to a holographic video display method, a holographic video display device, video data, and a video data creation method.

### BACKGROUND

Conventionally, devices displaying holographic videos are known. Patent Literature 1 and Patent Literature 2 disclose a holographic display fan having a blade provided with an LED light strip and a base provided with a motor 200 to which the blade is rotatably connected.

### CITATION LIST

### Patent Literature

Patent Literature 1: Japanese Utility Model Registration No. 3220306
Patent Literature 2: Japanese Patent No. 6866528

### SUMMARY

### Technical Problem

When a holographic video display device displays videos of text strings or images rotating in an annular shape or a spherical shape, the text strings or images are seen as if they moved three-dimensionally in an annular shape or a spherical shape, making it suitable for displaying text strings or images that are intended to attract people's attention, such as advertisements. However, if the characters or images displayed in the front of an annulus or a sphere and those displayed in the back of the annulus or the sphere have the same color, it is difficult to distinguish the characters in the front from those in the back, resulting in the problem that the characters or images cannot be seen three-dimensionally.

The present invention is, therefore, made to solve the above problem and an object of the present invention is to improve the visibility of characters or images displayed on a holographic video display device and to make them seen three-dimensionally.

### Solution to Problem

A holographic video display method of a first aspect of the present invention is a method of displaying a holographic video using a holographic video display device having a rotatable blade on which a plurality of light sources of three or more colors are arranged, the method including: a step of reading, from a storage medium, video data including a plurality of pieces of image data in which a plurality of images are arranged on a surface of an annular region or a spherical region, the images moving along the surface of the annular region or the spherical region; and a step of displaying a holographic video based on the video data by changing luminance of the light sources based on the video data, in the holographic video display device, in which in the pieces of image data, among the images, a color of a first image and a color of a second image at a point symmetry position with the first image with respect to a center of the annular region or the spherical region are different from each other.

The color of the first image and the color of the second image may be in complementary color relationship to each other.

The first image may contain a plurality of colors, and the second image may contain a plurality of colors different from the colors contained in the first image.

In the step of displaying a holographic video, the first image and the second image may be displayed in a state where the first image and the second image are overlapped with each other.

In the step of displaying a holographic video, among the first image and the second image, an image in a front side may be displayed larger than an image in a back side in the annular region or the spherical region.

A holographic video display device of a second aspect of the present invention includes: a rotatable blade on which a plurality of light sources of three or more colors are arranged; a processor configured to change luminance of the light sources based on video data including a plurality of pieces of image data in which a plurality of images are arranged on a surface of an annular region or a spherical region, the images moving along the surface of the annular region or the spherical region; and a motor configured to rotate the blade while the processor changes the luminance of the light sources, in which in the pieces of image data, among the images, a color of a first image and a color of a second image at a point symmetry position with the first image with respect to a center of the annular region or the spherical region are different from each other.

Video data of a third aspect of the present invention is video data used for displaying a holographic video using a holographic video display device having a rotatable blade on which a plurality of light sources of three or more colors are arranged, the video data including a plurality of pieces of image data in which a plurality of images are arranged on a surface of an annular region or a spherical region, in which in the pieces of image data, among the images, a color of a first image and a color of a second image at a point symmetry position with the first image with respect to a center of the annular region or the spherical region are different from each other.

A video data creation method of a fourth aspect of the present invention is a method of creating video data used for displaying a holographic video using a holographic video display device having a rotatable blade on which a plurality of light sources of three or more colors are arranged, the method being executed by a computer, the video data including a plurality of pieces of image data in which a plurality of images are arranged on a surface of an annular region or a spherical region, the video data creation method including creating the pieces of image data so that, among the images, a color of a first image and a color of a second image at a point symmetry position with the first image with respect to a center of the annular region or the spherical region are different from each other.

### Advantageous Effects of Invention

The present invention exerts an effect of improving the visibility of characters or images displayed on a holographic video display device and making them seen three-dimensionally.

### BRIEF DESCRIPTION OF DRAWINGS

FIG. 1 is a diagram illustrating a configuration of a holographic video display device S.

FIGS. 2A, 2B and 2C are diagrams illustrating a configuration of a fixing section 2.

FIG. 3 is a functional configuration diagram of the holographic video display device S.

FIGS. 4A, 4B and 4C are diagrams illustrating an example of a plurality of pieces of image data used by a processor 320 to display a holographic video.

### DESCRIPTION OF EMBODIMENTS

### Configuration of Holographic Video Display Device S

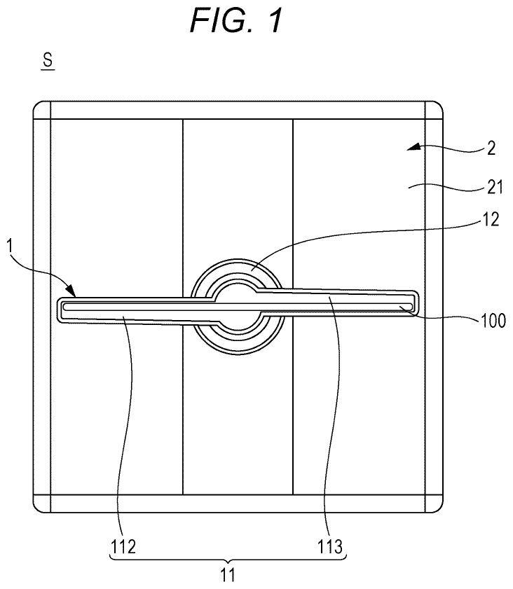

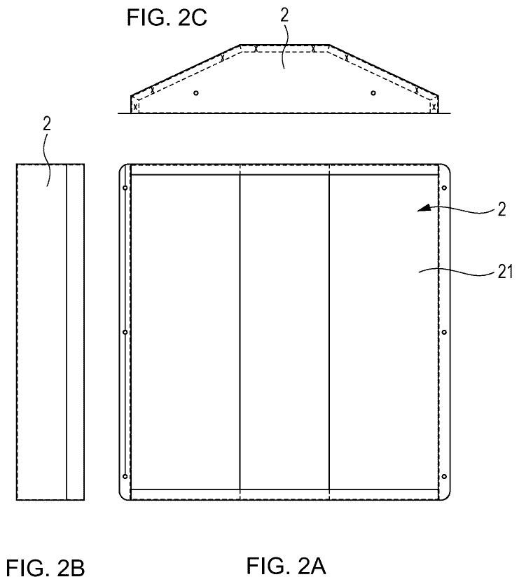

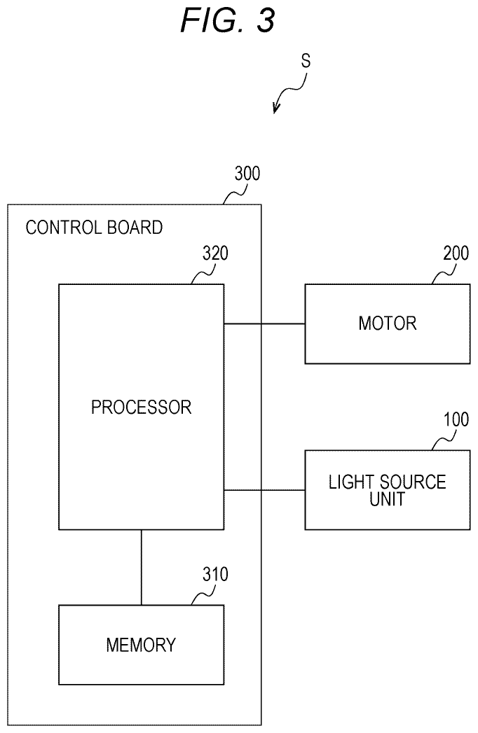

FIG. 1 is a diagram illustrating a configuration of a holographic video display device S. FIGS. 2A, 2B and 2C are diagrams illustrating a configuration of a fixing section 2. FIG. 2A is a front view of the fixing section 2. FIG. 2B is a side view of the fixing section 2. FIG. 2C is a top view of the fixing section 2. FIG. 3 is a functional configuration diagram of the holographic video display device S.

The holographic video display device S has a holographic display fan 1 and the fixing section 2. The fixing section 2 functions as a container for containing the holographic display fan 1. The fixing section 2 has a rear surface 21 of a black color on the holographic display fan 1 side. The holographic video display device S has the fixing section 2 of a black color on the rear surface 21, thereby allowing a video displayed by a light source unit 100 arranged on a blade 11 to be seen more easily.

The holographic display fan 1 has the blade 11 and a base 12. A side opposite to a side on which the blade 11 is provided in the base 12 is fixed to the rear surface 21. A transparent plate may be provided in the foreground (front side) of the holographic display fan 1.

The blade 11 rotates with the base 12 serving as a rotation shaft. The light source unit 100 is arranged in a straight line on the blade 11. The light source unit 100 includes a plurality of light emitting diodes (LEDs), which are a plurality of light sources in which three or more different colors (for example, red, green, blue) are arranged in order, for example. Specifically, in the light source unit 100, sets of LEDs of different colors, such as red, green, blue, red, green, blue, red, . . . , are arranged in different positions in a longitudinal direction of the blade 11. In addition, the blade 11 is provided with an insertion slot (not illustrated) into which an SD card storing video data to be displayed is inserted.

The blade 11 has a first blade 112 and a second blade 113. The first blade 112 and the second blade 113 are coupled to the rotation shaft of the motor 200 included in the base 12.

The base 12 has the motor 200, illustrated in FIG. 3, and a control board 300. The control board 300 has a memory 310 and a processor 320. The motor 200 rotates the blade 11 while the processor 320 changes the luminance of the light sources.

The memory 310 has a read only memory (ROM) in which a program executed by the processor 320 is stored, and a random access memory (RAM) used by the processor 320 as a work memory. The processor 320 is, for example, a central processing unit (CPU), which executes a program stored in the memory 310, to switch the LEDs included in the light source unit 100 between the lighting state and the off state based on the video data while rotating the motor 200, so as to display a hologram video.

### Method of Displaying Holographic Videos

The following is a detailed description of a method of displaying a holographic video using a holographic video display device S having a rotatable blade on which a plurality of light sources of three or more colors are arranged, the method being performed by the processor 320.

The processor 320 executes the step of reading, from a storage medium, video data in which a plurality of images move along a surface of an annular region or a spherical region. The video data includes a plurality of pieces of image data in which a plurality of images are arranged on a surface of an annular region or a spherical region, and in the pieces of image data, among the images, a color of a first image and a color of a second image at a point symmetry position with the first image with respect to a center of the annular region or the spherical region are different from each other. The processor 320 reads video data stored on an SD card attached to the blade 11, for example. The processor 320 may read video data stored in an external device.

The processor 320 then executes the step of displaying a holographic video based on the video data by changing luminance of the light sources based on the video data. In the step of displaying a holographic video, the processor 320 sequentially switches and displays the pieces of image data so that positions of the images change. Then, when the processor 320 displays the first image and the second image in a state where, among the images, the first image and the second image at a point symmetry position with the first image with respect to the center of the annular region or the spherical region are overlapped with each other, a viewer of the holographic video display device S sees the images arranged on the surface of an annulus or a sphere as if they rotate around the center of the annulus or the sphere as a rotation center.

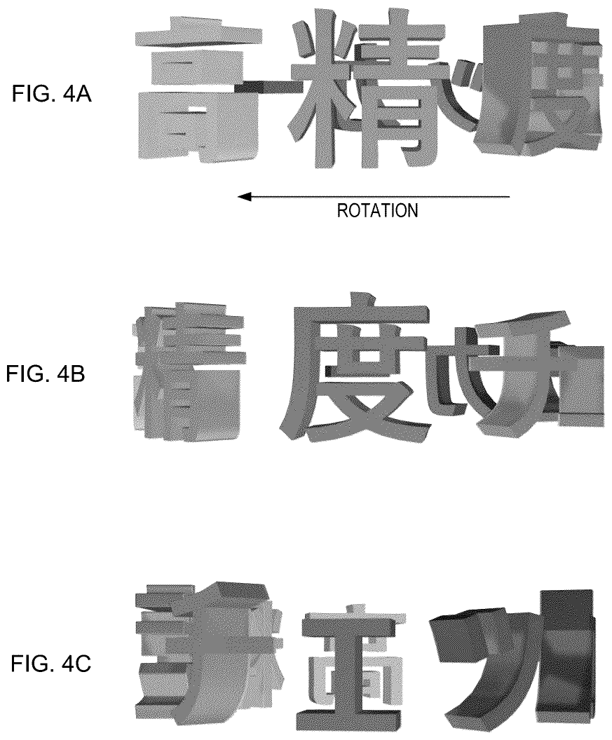

FIGS. 4A, 4B and 4C are diagrams illustrating an example of a plurality of pieces of image data used by the processor 320 to display a holographic video. In FIGS. 4A, 4B and 4C, an example of a plurality of pieces of image data in which a plurality of images are arranged on a surface of an annular region is illustrated. In the pieces of image data illustrated in FIGS. 4A, 4B and 4C, eight characters “ [symbol] ” (“High Precision Checker”) are contained in a state of being arranged in an annular shape. FIGS. 4A, 4B and 4C illustrate three pieces of image data changing in the order of FIG. 4A, FIG. 4B, and FIG. 4C, and also includes a plurality of pieces of image data in which positions of a plurality of images (characters) are slightly different from each other between FIG. 4A and FIG. 4B, and between FIG. 4B and FIG. 4C. As time passes, the image data changes in the order of FIG. 4A, FIG. 4B, and FIG. 4C, so that the viewer of the holographic video display device S sees the character string as if it rotates annularly.

However, if the characters displayed in the front (for example, “ [symbol] ” in FIG. 4A) and the characters displayed in the back (for example, the horizontally reversed character of “ [symbol] ” in FIG. 4A) have the same color, the characters in the front and the characters in the back are seen in an integrated state, and it is difficult to distinguish the characters and the character string is illegible as if it rotates annularly.

Therefore, in the pieces of image data displayed by the processor 320, among the images, the color of the first image and the color of the second image at a point symmetry position with the first image with respect to the center of the annular region or the spherical region are different from each other. In the example in FIG. 4A, the color of the character “ [symbol] ” is different from the color of the character “ [symbol] ”. In the example in FIG. 4B, the color of the character “ [symbol] ” is different from the color of the character “ [symbol] ”. In the example in FIG. 4C, the color of the character “ [symbol] ” is different from the color of the character “ [symbol] ”. Thus, with the colors of the images at point symmetry positions with respect to the center of the annular region or the spherical region being different from each other, the images are not integrated. Thus, the viewer of the holographic video display device S can distinguish the images (for example, characters), and the images are seen as if they rotate annularly.

To improve the distinguishability of the images at point symmetry positions with respect to the center of the annular region or the spherical region, the color of the first image and the color of the second image may be in a complementary color relationship to each other. The complementary color relationship is a relationship positioning on the opposite sides of the hue ring, and can be either a physical complementary color relationship or psychological complementary color relationship.

As an example, in the example of FIG. 4A, the character “ [symbol] ” is red and the character “ [symbol] ” is cyan. In the example in FIG. 4B, the character “ [symbol] ” is magenta and the character “ [symbol] ” is green. Thus, it is desirable that the colors of adjacent images among the images are not in a complementary relationship and are similar to each other. By structuring the image data in this way, even if there is a region in which the image in the front partially overlaps with an image adjacent to another image at a point symmetry position with respect to the center of the annular region or the spherical region, the distinguishability of the region is not reduced.

Each of the images included in the image data may contain a plurality of colors. Specifically, the first image may contain a plurality of colors, and the second image may contain a plurality of colors that are different from the colors contained in the first image. As an example, the character “ [symbol] ” in FIGS. 4A, 4B and 4C are colored so that it changes from red to magenta as it moves from left to right, and the character “ [symbol] ” is colored so that it changes from cyan to green as it moves from left to right. The visual effect is enhanced by the fact that the image data is structured in such a way that a plurality of images are seen to rotate with gradually changing colors in an annular shape or a spherical shape.

To make the images arranged in an annular shape or a spherical shape seen more three-dimensional, the processor 320 may display, in the step of displaying a holographic video, the images in the front side larger than the images in the back side in the annular region or the spherical region, among the first image and the second image. In the example illustrated in FIG. 4A, the character “ [symbol] ” is larger than the character “ [symbol] ”, and in the example illustrated in FIG. 4B, the character “ [symbol] ” is larger than the character “ [symbol] ”

### Method for Creating Video Data

The video data described above can be created using a computer. As an example, by executing a program for creating video data, a computer executes a method for creating video data used to display a holographic video using a holographic video display device having a rotatable blade on which a plurality of light sources of three or more colors are arranged.

As described above, the video data includes a plurality of pieces of image data in which a plurality of images are arranged on a surface of an annular region or a spherical region, and the computer creates the video data by creating the pieces of image data so that, among the images, the color of the first image and the color of the second image at a point symmetry position with the first image with respect to the center of the annular region or the spherical region are different from each other. The computer inputs the video data to the holographic video display device S via a communication medium or via a storage medium, thereby enabling the holographic video display device S to display a hologram video.

### Effects Achieved by Holographic Video Display Device S

As explained above, the holographic video display device S includes: the processor 320 configured to change luminance of the light sources based on video data including a plurality of pieces of image data in which a plurality of images are arranged on a surface of an annular region or a spherical region, the images moving along the surface of the annular region or the spherical region; and the motor 200 configured to rotate the blade 11 while the processor 320 changes the luminance of the light sources. Then, in the pieces of image data, among the images, the color of the first image and the color of the second image at a point symmetry position with the first image with respect to the center of the annular region or the spherical region are different from each other.

When the holographic video display device S displays such video data, the viewer of the holographic video display device S can distinguish the image in the front and the image in the back while watching a three-dimensional video in which a plurality of images arranged in an annular shape or a spherical shape rotate around a center of an annulus or a sphere, and thus the visual effect is enhanced. In particular, in a case where the images are character images, the characters in the front can be distinguished from the characters in the back, and thus the viewer of the holographic video display device S can easily grasp the contents of the character string. Therefore, in a case where the holographic video display device S is installed at an exhibition or a store to display advertising characters, the advertisement effect is enhanced.

Although the present invention has been described above with reference to the embodiments, the technical scope of the present invention is not limited to the scope described in the above embodiments, and various variations and modifications are possible within the scope of the gist thereof. For example, all or part of the device can be functionally or physically distributed and integrated in any unit. In addition, a new embodiment resulting from any combination of a plurality of embodiments is also included in the present invention. Effects of the new embodiment resulting from the combination also include the effects of the original embodiments.

1. A holographic video display method of displaying a holographic video using a holographic video display device having a rotatable blade on which a plurality of light sources of three or more colors are arranged, the holographic video display method comprising:
a step of reading, from a storage medium, video data including a plurality of pieces of image data in which a plurality of images are arranged on a surface of an annular region or a spherical region, the images moving along the surface of the annular region or the spherical region; and
a step of displaying a holographic video based on the video data by changing luminance of the light sources based on the video data, in the holographic video display device, wherein
in the pieces of image data, among the images, a color of a first image and a color of a second image at a point symmetry position with the first image with respect to a center of the annular region or the spherical region are different from each other.

2. The holographic video display method according to claim 1, wherein the color of the first image and the color of the second image are in a complementary color relationship to each other.

3. The holographic video display method according to claim 1, wherein the first image contains a plurality of colors, and the second image contains a plurality of colors different from the colors contained in the first image.

4. The holographic video display method according to claim 1, wherein in the step of displaying a holographic video, the first image and the second image are displayed in a state where the first image and the second image are overlapped with each other.

5. The holographic video display method according to claim 1, wherein, in the step of displaying a holographic video, among the first image and the second image, an image in a front side is displayed larger than an image in a back side in the annular region or the spherical region.

6. A holographic video display device comprising:
a rotatable blade on which a plurality of light sources of three or more colors are arranged;
a processor configured to change luminance of the light sources based on video data including a plurality of pieces of image data in which a plurality of images are arranged on a surface of an annular region or a spherical region, the images moving along the surface of the annular region or the spherical region; and
a motor configured to rotate the blade while the processor changes the luminance of the light sources, wherein
in the pieces of image data, among the images, a color of a first image and a color of a second image at a point symmetry position with the first image with respect to a center of the annular region or the spherical region are different from each other.

7. A video data creation method that is a method of creating video data used for displaying a holographic video using a holographic video display device having a rotatable blade on which a plurality of light sources of three or more colors are arranged, the method being executed by a computer
the video data including a plurality of pieces of image data in which a plurality of images are arranged on a surface of an annular region or a spherical region, the video data creation method comprising creating the pieces of image data so that, among the images, a color of a first image and a color of a second image at a point symmetry position with the first image with respect to a center of the annular region or the spherical region are different from each other.
